(19) United States
(12) Patent Application Publication
(10) Pub. No.: US 2018/0288841 A1
(43) Pub. Date: Oct. 4, 2018

(54) LIGHTING SYSTEMS INCLUDING ELECTRICAL FEEDBACK FOR FAILURE OF LIGHT PRODUCING ELEMENTS, CURING SYSTEMS INCLUDING SUCH LIGHTING SYSTEMS, AND METHODS OF OPERATING THE SAME

(71) Applicant: Heraeus Noblelight America LLC, Gaithersburg, MD (US)

(72) Inventors: Mahmood Gharagozloo, Gaithersburg, MD (US); Darrin Leonhardt, Gaithersburg, MD (US); Yixin Yang, Olney, MD (US); William E. Johnson, III, Burke, VA (US)

(21) Appl. No.: 15/935,217

(22) Filed: Mar. 26, 2018

Related U.S. Application Data
(60) Provisional application No. 62/478,301, filed on Mar. 29, 2017.

(51) Int. Cl. H05B 33/08; H05B 37/02; B05D 3/06; F26B 3/28

(52) U.S. Cl. CPC H05B 33/089; H05B 33/0827; F26B 3/28; B05D 3/067; H05B 37/0227

(57) ABSTRACT

A lighting system is provided. The lighting system includes: a plurality of light producing elements, the plurality of light producing elements being arranged in an array including a plurality of branches connected in an electrically parallel configuration with respect to one another, each of the plurality of branches including a plurality of the light producing elements arranged in an electrically series configuration with respect to one another; a plurality of driver circuits, each of the plurality of driver circuits providing electrical energy to a respective one of the plurality of branches; and a processor for detecting failure of one or more of the light producing elements, and adjusting electrical energy provided by at least one of the plurality of driver circuits based on the detection of the failure of the one or more light producing elements.

### CROSS-REFERENCE TO RELATED APPLICATION

This application claims the benefit of U.S. Provisional Patent Application No. 62/478,301, filed Mar. 29, 2017, the contents of which are incorporated herein by reference.

### FIELD

The invention relates to lighting systems, and more particularly, to improved lighting systems using electrical feedback for failure of light producing elements in the operation of the lighting systems.

### BACKGROUND

Traditional lighting systems may include an array of light producing elements. In certain configurations, the array includes a plurality of branches in electrical parallel with respect to one another, where each branch includes a plurality of light producing elements in electrical series with respect to one another.

In such configurations, the failure of any light producing element in the array may contribute to the loss of optical output of the lighting system. This loss of optical output may result in production downtime, production degradation, maintenance expenses, and component replacement.

Thus, it would be desirable to provide improved lighting systems, improved curing systems including such lighting systems, and improved methods of operating such lighting systems.

### SUMMARY

According to an exemplary embodiment of the invention, a lighting system is provided. The lighting system includes: a plurality of light producing elements, the plurality of light producing elements being arranged in an array including a plurality of branches connected in an electrically parallel configuration with respect to one another, each of the plurality of branches including a plurality of the light producing elements arranged in an electrically series configuration with respect to one another; a plurality of driver circuits, each of the plurality of driver circuits providing electrical energy to a respective one of the plurality of branches; and a processor for detecting failure of one or more of the light producing elements, and adjusting electrical energy provided by at least one of the plurality of driver circuits based on the detection of the failure of the one or more light producing elements.

According to another exemplary embodiment of the invention, a curing system for curing a coating on a workpiece is provided. For example, the workpiece with a coating may be an optical fiber with a coating, a wire with a coating, a pipe with a coating, a paper or other workpiece with an ink coating, or any other element with a coating requiring curing. The curing system includes a lighting system including a plurality of light producing elements. The plurality of light producing elements are arranged in an array including a plurality of branches connected in an electrically parallel configuration with respect to one another. Each of the plurality of branches includes a plurality of the light producing elements arranged in an electrically series configuration with respect to one another. The lighting system also includes a plurality of driver circuits. Each of the plurality of driver circuits provides electrical energy to a respective one of the plurality of branches. The lighting system also includes a processor for detecting failure of one or more of the light producing elements. The processor is configured to adjust electrical energy provided by at least one of the plurality of driver circuits based on the detection of the failure of the one or more light producing elements. The lighting system also includes a workpiece configured to receive light from the lighting system to cure a coating on the workpiece.

According to yet another exemplary embodiment of the invention, a method of operating a lighting system is provided. The method includes the steps of: (a) providing a lighting system including a plurality of light producing elements, the plurality of light producing elements being arranged in an array including a plurality of branches connected in an electrically parallel configuration with respect to one another, each of the plurality of branches including a plurality of the light producing elements arranged in an electrically series configuration with respect to one another; (b) providing electrical energy to each of the plurality of branches using a plurality of driver circuits; (c) monitoring an operational status of each of the branches of the plurality of light producing elements; and (d) adjusting electrical energy provided to at least a portion of the plurality of light producing elements based on a detection of a failure one or more light producing elements.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a block diagram of a lighting system in accordance with an exemplary embodiment of the invention;

FIG. 2 is a block diagram of a curing system including a lighting system in accordance with an exemplary embodiment of the invention; and

FIG. 3 is a flow diagram illustrating a method of operating a lighting system in accordance with an exemplary embodiment of the invention.

### DETAILED DESCRIPTION

According to aspects of the invention, improvements are provided to lighting systems (e.g., infrared lighting systems, visible lighting systems, ultraviolet lighting systems, etc.) which include a parallel/series configuration of light producing elements. In one specific example, the lighting system may be an ultraviolet (UV) array of LED light producing elements, where the LED light producing elements are provided in a plurality of parallel branches, where each of the parallel branches includes a plurality of the light producing elements arranged in a series configuration.

According to the invention, the failure of one or more light producing elements (e.g., LEDs) is monitored (detected, for example, using a processor or similar component), and the electrical power to one or more branches of the array is adjusted to compensate for the failure. More specifically, “intelligence” may be built into the lighting system to detect a failure condition, and to compensate for the failure condition (e.g., according to predetermined criteria) using hardware and/or software control. The failure may be detected, for example, by monitoring the voltage and/or current being transmitted from each of the plurality of driver circuits to the corresponding branches of the array. By compensating for the failure of one or more of the light producing elements (through the operation of a so called “boost mode”), a substantial overall loss of optical output may be prevented.

Exemplary features related to various embodiments of the invention include: (1) an array of light producing elements including a plurality of branches in electrical parallel, and a plurality of light producing elements in electrical series in each of the branches; (2) each of the branches includes a driver circuit, including control and monitoring circuitry (e.g., circuitry to monitor current in each branch, circuitry to monitor voltage across each branch, etc.; (3) temperature measurement circuitry may also be included at each driver circuit to measure the temperature of critical components; and (4) a processor (and/or additional circuitry) receiving information from each driver circuit (e.g., related to the monitored characteristics) to detect the failure condition and to operate the remaining light producing elements in a different mode (e.g., a boost mode).

In accordance with exemplary aspects of the invention, after detection of the failure of one or more light producing elements, the actual adjustment to the electrical energy provided to some (or all) of the remaining light producing elements may be controlled using certain criteria. For example, the ambient temperature, the number of parallel/series configurations, and/or the design absolute maximum margin in the given application. Further, an early alert warning signal may be provided to the end user to: signal the activation of the adjusted electrical energy (e.g., automatically entering the boost mode); or allow the user to choose activation of the adjusted electrical energy. By providing this warning signal, the user can plan for system maintenance at their convenience.

As used herein, the term “processor” (which may also be used interchangeably with the term “microprocessor”) shall be broadly construed to refer to any device including a processing unit (e.g., a central processing unit) or other hardware that executes computer program instructions. Examples of “processors” and “microprocessors” include microcontrollers, digital signal processors (DSPs), programmable logic controllers (PLCs), computers, etc. As is understood by those skilled in the art, “processors” and “microprocessors” may include elements such as random access memory (RAM), read only memory (ROM), and peripherals.

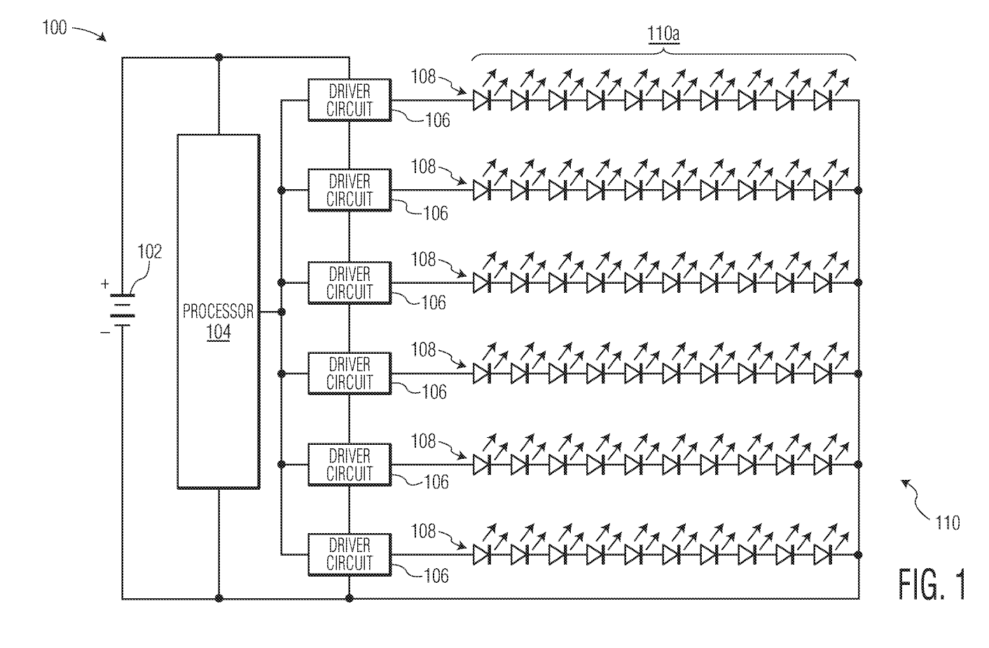

FIG. 1 illustrates a lighting system 100 (e.g., an ultraviolet light emitting diode, UV LED, system). Lighting system 100 includes a power supply 102 and a processor 104 (including, or with access to, software for implementing a method of operating the lighting system). Lighting system 100 also includes an array 110 of light producing elements (UV LEDs) 110a. As shown in FIG. 1, array 110 includes a plurality of branches 108 electrically in a parallel configuration with respect to one another. Each branch 108 includes a plurality of light producing elements 110a arranged electrically in a series configuration with respect to one another. FIG. 1 illustrates a very specific array including a specific number of branches 108, and a specific number of light producing elements 110a in each branch. Of course, the type of light producing elements 110a (e.g., light producing elements other than UV LEDs), the number of branches 108, and the number of light producing elements 110 in each branch 108, may vary as desired in the given application.

A driver circuit 106 is provided for each branch 108. The driver circuit 106 is controlled by processor 104, and provides electrical energy to the respective branch 108. As will be appreciated by one skilled in the art, each driver circuit 106 may include additional elements such as voltage measurement circuitry (for measuring the voltage across the respective branch), current measurement circuitry (for measuring the current applied to the respective branch), and temperature measurement circuitry (for measuring the temperature of components of the respective driver circuit). Information from each of these elements of driver circuit 106 (e.g., voltage measurements, current measurements, temperature measurements, etc.) may be provided back to processor 104 for controlling electrical energy provided to each branch 108. Specifically, this information may be used to monitor the operational status of each of the branches 108, for example, to predict a failure of one or more of the light producing elements 110a. With this information, processor 104 may adjust the electrical energy provided to each of the branches 108 (or just to specific ones of the branches 108), according to software accessible to processor 104.

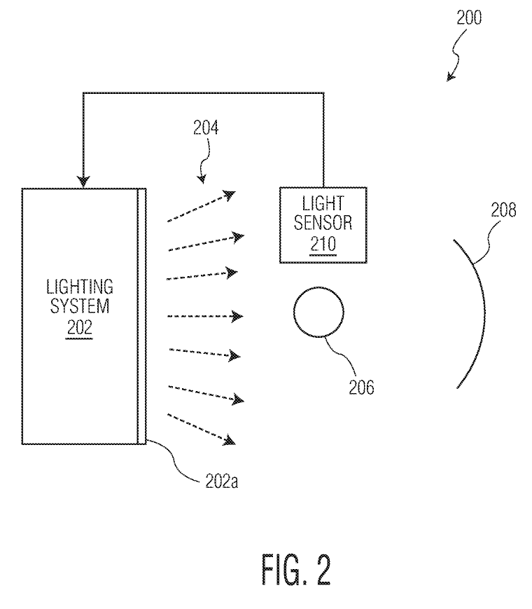

Lighting systems according to the invention may be used in a number of applications. One specific application is in curing of a coating applied to a workpiece (e.g., an optical fiber with a coating, a wire with a coating, a pipe with a coating, a paper or other workpiece with an ink coating, or any other element with a coating requiring curing). FIG. 2 illustrates an exemplary curing system 200 (e.g., a UV curing system). Curing system 200 includes a lighting system 202 (which may be lighting system 100 shown in FIG. 1, or any other lighting system within the scope of the invention). Lighting system 202 includes array 202a of light producing elements (e.g., such as array 100 of FIG. 1). Light 204 is directed from array 202a towards workpiece 206. Workpiece 206 may include a coating requiring curing using lighting system 202. Light 204 may strike workpiece 206 directly, and/or may be reflected from one or more reflectors 208 back to workpiece 206.

Curing system 200 also includes light sensor 210 for sensing light output from the plurality of light producing elements (i.e., light 204). Information from light sensor 210 is provided to the processor (included in lighting system 200, for example, see processor 104 in FIG. 1) for use in adjusting electrical energy provided by at least one of the plurality of driver circuits (e.g., see driver circuits 106 in FIG. 1). That is, information from light sensor 210 (e.g., light measurements, etc.) may be provided back to the processor (e.g., processor 104 in FIG. 1) for use in controlling electrical energy provided to each branch of array 202a. Such information may be used in addition to, or in lieu of, other feedback information described herein (e.g., voltage measurements, current measurements, temperature measurements, etc.).

Specifically, this light measurement information may be used to monitor the operational status of each of the branches, for example, to predict a failure of one or more of the light producing elements. With this information, the processor may adjust the electrical energy provided to each of the branches, according to software accessible to the processor.

For example, the adjustment of electrical energy (resulting from measurements from light sensor 210) could be based on the aging of the light source (the light producing elements), some environmental impact, among other reasons. In a lighting system (or method) according to the invention that includes measurement circuitry for measuring electrical measurements related to the light source (e.g., voltage, current, etc.), it is very useful to also have information from such a light sensor 210. Any lighting system within the scope of the invention, including system 100 from FIG. 1 (not just for curing applications, but for any application), may include such a light sensor such as light sensor 210. For example, it can be determined if the reduction in the total output light is related a failure (which would be evident from the electrical measurements) or some other reason (e.g., age, environment, etc.). In any event, the inventive systems and methods may be used to maintain a constant (or substantially constant) output light.

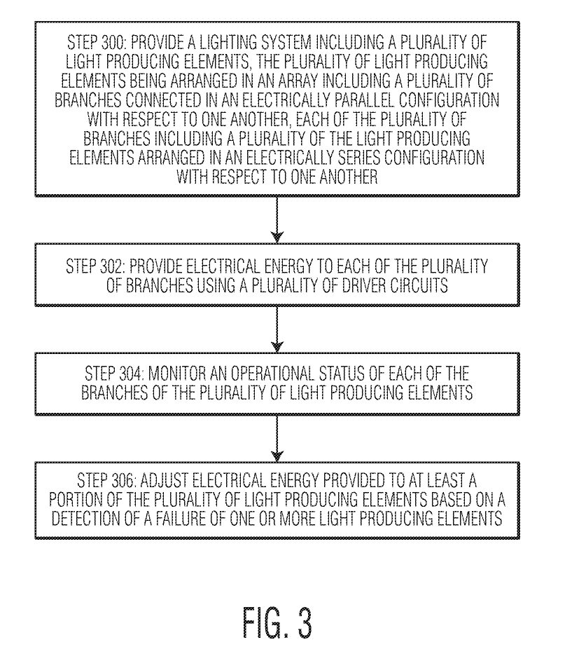

FIG. 3. is a flow diagram illustrating a method of operating a lighting system (e.g., lighting system 100 in FIG. 1, lighting system 202 in FIG. 2, or any other lighting system within the scope of the invention) in accordance with an exemplary embodiment of the invention. As is understood by those skilled in the art, certain steps included in the flow diagram may be omitted; certain additional steps may be added; and the order of the steps may be altered from the order illustrated. At Step 300, a lighting system is provided including a plurality of light producing elements. The plurality of light producing elements are arranged in an array including a plurality of branches connected in an electrically parallel configuration with respect to one another, each of the plurality of branches including a plurality of the light producing elements arranged in an electrically series configuration with respect to one another (e.g., see array 110 of FIG. 1). At Step 302, electrical energy is provided to each of the plurality of branches using a plurality of driver circuits (e.g., see driver circuits 106 providing electrical energy to branches 108, as shown in FIG. 1). At Step 304, an operational status of each of the branches of the plurality of light producing elements is monitored. For example, at least one of a current and a voltage for each of the branches is measured using measurement circuitry—where such measurement circuitry may be included at the driver circuit (see driver circuits 106 as shown in FIG. 1) for the relevant branch. At Step 306, the electrical energy provided to at least a portion of the plurality of light producing elements is adjusted based on a detection of a failure one or more light producing elements. In one example, the electrical energy provided by the plurality of driver circuits may be adjusted such that a light energy provided by each of the branches is substantially equal to one another. In another example, upon detection of a short circuit condition of a light producing element in one of the branches in Step 304 (e.g., by the detection of a predetermined voltage change (e.g., drop) to a branch using the measurement circuitry), Step 306 may include increasing the electrical energy provided to at least one of the branches by the corresponding driver circuit. In another example, upon detection of an open circuit condition of a light producing element in one of the branches in Step 304 (e.g., by the detection of a loss of current to a branch using the measurement circuitry), Step 306 may include increasing the electrical energy provided to at least one of the other branches by the corresponding driver circuits.

Aspects of the invention provide important benefits. For example, failure of light producing elements may be predicted, and the output light from the lighting system may be adjusted to compensate for the reduction caused by the failure. For example, a constant (or substantially constant) light output may be provided, even with failure of up to a predetermined percentage of the light producing elements (e.g., 25%). Such a design allows extended use of the product until an appropriate time for maintenance or service.

Importantly, through the use of certain of the inventive systems and methods described herein, an objective of maintaining a constant (or substantially constant) level of output photons (light) may be achieved.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A lighting system comprising:
a plurality of light producing elements, the plurality of light producing elements being arranged in an array including a plurality of branches connected in an electrically parallel configuration with respect to one another, each of the plurality of branches including a plurality of the light producing elements arranged in an electrically series configuration with respect to one another;
a plurality of driver circuits, each of the plurality of driver circuits providing electrical energy to a respective one of the plurality of branches; and
a processor for detecting failure of one or more of the light producing elements, and adjusting electrical energy provided by at least one of the plurality of driver circuits based on the detection of the failure of the one or more light producing elements.

2. The lighting system of claim 1 wherein the plurality of light producing elements are ultraviolet LED elements.

3. The lighting system of claim 1 further comprising measurement circuitry for measuring at least one of a current and a voltage for each of the branches.

4. The lighting system of claim 3 wherein the processor detects a failure of one or more of the light producing elements using information provided by the measurement circuitry.

5. The lighting system of claim 1 further comprising temperature measurement circuitry for measuring a temperature of components of the lighting system, and providing the measured temperature of the components to the processor.

6. The lighting system of claim 1 wherein the processor adjusts the electrical energy provided by the plurality of driver circuits such that a light energy provided by each of the branches is substantially equal.

7. The lighting system of claim 1 wherein, upon detection of a short circuit condition of a light producing element in one of the branches, the electrical energy provided to the one of the branches is increased by the corresponding driver circuit.

8. The lighting system of claim 1 wherein, upon detection of an open circuit condition of a light producing element in one of the branches, the electrical energy provided to at least one of the other branches is increased by the corresponding driver circuits.

9. The lighting system of claim 1 wherein the lighting system is a curing system for curing a coating applied to a workpiece.

10. The lighting system of claim 1 further comprising a light sensor for sensing a light output from the plurality of light producing elements, wherein information from the light sensor is provided to the processor for use in adjusting electrical energy provided by at least one of the plurality of driver circuits.

11. The lighting system of claim 10, wherein the light sensor is an ultraviolet light sensor.

12. A curing system for curing a coating on a workpiece, the curing system comprising:
(a) a lighting system including a plurality of light producing elements, the plurality of light producing elements being arranged in an array including a plurality of branches connected in an electrically parallel configuration with respect to one another, each of the plurality of branches including a plurality of the light producing elements arranged in an electrically series configuration with respect to one another, the lighting system also including a plurality of driver circuits, each of the plurality of driver circuits providing electrical energy to a respective one of the plurality of branches, the lighting system also including a processor for detecting failure of one or more of the light producing elements, the processor configured to adjust electrical energy provided by at least one of the plurality of driver circuits based on the detection of the failure of the one or more light producing elements; and
(b) a workpiece configured to receive light from the lighting system to cure a coating on the workpiece.

13. A method of operating a lighting system, the method comprising the steps of:
(a) providing a lighting system including a plurality of light producing elements, the plurality of light producing elements being arranged in an array including a plurality of branches connected in an electrically parallel configuration with respect to one another, each of the plurality of branches including a plurality of the light producing elements arranged in an electrically series configuration with respect to one another;
(b) providing electrical energy to each of the plurality of branches using a plurality of driver circuits;
(c) monitoring an operational status of each of the branches of the plurality of light producing elements; and
(d) adjusting electrical energy provided to at least a portion of the plurality of light producing elements based on a detection of a failure one or more light producing elements.

14. The method of claim 13 wherein step (c) includes measuring at least one of a current and a voltage for each of the branches using measurement circuitry.

15. The method of claim 13 wherein step (d) includes adjusting the electrical energy provided by the plurality of driver circuits such that a light energy provided by each of the branches is substantially equal.

16. The method of claim 13 wherein, upon detection of a short circuit condition of a light producing element in one of the branches in step (c), step (d) includes increasing the electrical energy provided to at least one of the branches by the corresponding driver circuit.

17. The method of claim 13 wherein, upon detection of an open circuit condition of a light producing element in one of the branches in step (d), step (d) includes increasing the electrical energy provided to at least one of the other branches by the corresponding driver circuits.

18. The method of claim 13 wherein the lighting system is a curing system for curing a coating applied to a workpiece.

19. The method of claim 13 further comprising step of (e) sensing a light output from the plurality of light producing elements using a light sensor, wherein information from the light sensor is used in adjusting electrical energy provided by at least one of the plurality of driver circuits.

20. The method of claim 19, wherein the light sensor is an ultraviolet light sensor.
